(19) United States
(12) Patent Application Publication
(10) Pub. No.: US 2008/0279364 A1
(43) Pub. Date: Nov. 13, 2008

(54) COMMUNICATION APPARATUS AND REMOTE CONTROL METHOD USED IN COMMUNICATION SYSTEM

(75) Inventors: Takanori Kaji, Tokyo (JP); Shuichi Sato, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/109,591

(22) Filed: Apr. 25, 2008

(30) Foreign Application Priority Data
May 10, 2007 (JP) 2007-125830

(51) Int. Cl. H04M 3/00

(52) U.S. Cl. 379/283

(57) ABSTRACT

According to one embodiment, a communication apparatus includes a receiver which receives a Dual Tone Multi Frequency (DTMF) signal for specifying a control request is transmitted from a management apparatus, the control request including connection destination information for specifying a management apparatus, the management apparatus is connected to the public network and remotely controls the communication process, a calculator which obtains a control request from the DTMF signal, and a controller which creates a session for management using a known protocol passable through the firewall with respect to the management apparatus based on the connection destination information included in the control request, and allows the management apparatus to execute a process based on contents of the control request.

### CROSS-REFERENCE TO RELATED APPLICATIONS

This application is based upon and claims the benefit of priority from Japanese Patent Application No. 2007-125830, filed May 10, 2007, the entire contents of which are incorporated herein by reference.

### BACKGROUND

1. Field

One embodiment of the present invention relates to a communication apparatus which is remotely controlled via an Internet Protocol (IP) network or a public network by a management apparatus such as a personal computer, and a remote control method for the communication apparatus.

2. Description of the Related Art

Telephone exchange apparatuses detect internal or external abnormality encountered during a process, and record the detected results as error/alarm log files into a built-in memory of a line/terminal connection card. When software calling/maintenance process is executed, exchanged messages and their contents can be recorded as log files in the built-in memory of the line/terminal connection card.

When the telephone exchange apparatuses collect log files of line/terminal connection cards, and update program, control services and change settings, they can execute these processes normally by connecting via serial ports or Ethernet (registered trademark) ports.

However, in an actual operation, even if the apparatuses are connected to an IP network, since the apparatuses are connected to intra-firm LAN, the apparatuses should pass through a firewall apparatus to be connected to an external network. For this reason, when a maintenance operation is performed remotely from the outside, the number of rules for passing through the firewall apparatus should be increased, or an environment for secure connection such as virtual private network (VPN) should be prepared. When such an environment cannot be prepared, maintenance staff goes to an installation place of the telephone exchange apparatus, and connects the management apparatus such as a personal computer to the telephone exchange apparatus via a serial port or an Ethernet (registered trademark), so as to collect files, update programs, control services and change settings. Therefore, the maintenance takes a lot of time and labors. When the maintenance staff is continuously present near the telephone exchange apparatus, the maintenance staff can collect log files, update programs, control services and change settings immediately. However, the maintenance staff is mostly present at a quarter far from the installation place of the telephone exchange apparatus.

The following method (for example, Jpn. Pat. Appln. KOKAI Publication No. 10-336351) is considered for the case where log files to be recorded in the built-in memory of the telephone exchange apparatus are collected via a communication network such as Internet by remote control from the management apparatus. In this method, after the log files are constituted into commands composed of hexadecimal data strings in the telephone exchange apparatus, the commands are converted according to a dual tone multi frequency (DTMF) signal so as to be transmitted, the DTMF signal is inversely converted into the hexadecimal data strings so that the commands are restored and analyzed by the management apparatus.

However, with the above method, when log files in the telephone exchange apparatus are collected by the management apparatus via the communication network, access limitation to the firewall on the communication network should be relaxed. Since this increases the risk of an attack by an illegitimate third party, this method is not accepted by most administrators.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic constitutional diagram illustrating a communication system according to a first embodiment of the present invention;

FIG. 2 is a block diagram illustrating a functional constitution of a telephone main apparatus shown in FIG. 1;

FIG. 3 is a diagram illustrating one example of a table showing a correspondence relationship between DTMF and ASCII codes (hexadecimal form) to be stored in a memory unit shown in FIG. 2;

FIG. 4 is a diagram illustrating one example of a table showing a correspondence relationship between ASCII codes and text character strings to be stored in the memory unit shown in FIG. 2;

FIG. 5 is a sequence diagram illustrating an operation for establishing a connection for control between a maintenance apparatus and the telephone main apparatus according to the first embodiment; and

FIG. 6 is a sequence diagram illustrating an operation for establishing the connection for control between the maintenance apparatus and the telephone main apparatus according to a second embodiment of the present invention.

### DETAILED DESCRIPTION OF THE INVENTION

Various embodiments according to the invention will be described hereinafter with reference to the accompanying drawings, in general, according to one embodiment of the invention, a communication apparatus which is connected to a local area network, is connectable to a public network arranged more widely than the local area network via a firewall, and executes a predetermined communication process, the apparatus comprising: a receiver which receives a Dual Tone Multi Frequency (DTMF) signal for specifying a control request is transmitted from a management apparatus, the control request including connection destination information for specifying a management apparatus, the management apparatus is connected to the public network and remotely controls the communication process; a calculator which obtains a control request from the DTMF signal; and a controller which creates a session for management using a known protocol passable through the firewall with respect to the management apparatus based on the connection destination information included in the control request, and allows the management apparatus to execute a process based on contents of the control request.

### First Embodiment

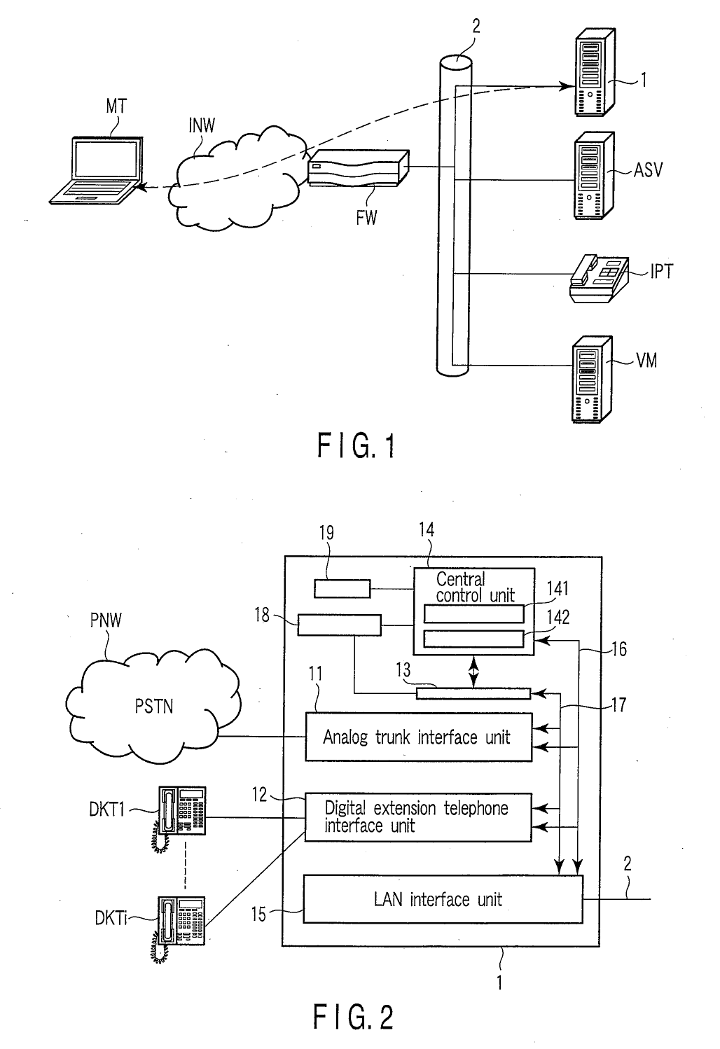

FIG. 1 is a schematic constitutional diagram illustrating a communication system according to a first embodiment of the present invention, and reference numeral 1 designates a telephone main apparatus. The telephone main apparatus 1 is connected to an application server ASV, a telephone terminal IPT and a voice mail apparatus VM via Local Area Network (LAN) 2.

The telephone main apparatus 1 is connected to a public network INW such as Internet, arranged more widely than the LAN 2, via the LAN 2 and a firewall FW, and is further connected from the public network INW to a maintenance apparatus MT.

FIG. 2 is a block diagram illustrating a functional constitution of the telephone main apparatus 1.

The telephone main apparatus 1 includes an analog trunk interface unit 11, a digital extension telephone interface unit 12, a time switch 13, a central control unit (hereinafter, CPU) 14, and a LAN interface unit 15. The analog trunk interface unit 11, the digital extension telephone interface unit 12, the CPU 14 and the LAN interface unit 15 are connected to one another via a control bus 16. The analog trunk interface unit 11, the digital extension telephone interface unit 12, the time switch 13 and the LAN interface unit 15 are connected to one another via an audio bus 17.

The analog trunk interface unit 11 is connected to a public network PNW, and executes a process for establishing a call with the public network PNW.

The digital extension telephone interface unit 12 houses a plurality of extension terminals DKT1 to DKTi (i is a natural number). An example of the extension terminals DKT1 to DKTi is a digital telephone set. The digital extension telephone interface unit 13 executes an outgoing/incoming process with respect to the extension terminals DKT1 to DKTi and a transmission process of a digital signal.

The time switch 13 switches to be connected among the analog trunk interface unit 11, the digital extension telephone interface unit 12 and the LAN interface unit 15 according to an instruction from the CPU 14. The time switch 13 is connected to a DTMF detecting unit 18. The DTMF detecting unit 18 detects a DTMF signal so as to output the detected result to the CPU 14.

The LAN interface unit 15 is connected to the LAN 2, and executes an interface process with respect o the LAN 2.

The CPU 14 has normal control functions such as an outgoing process associated with a calling request from the extension terminals DKT1 to DKTi, a normal incoming process associated with outside line incoming from the public network PNW, a transmission process among the extension terminals DKT1 to DKTi, and a communication process among an application server ASV, a telephone terminal IPT and a voice mail apparatus VM on the LAN 2. Further, the CPU 14 includes a data format conversion control unit 141 and an access control unit 142.

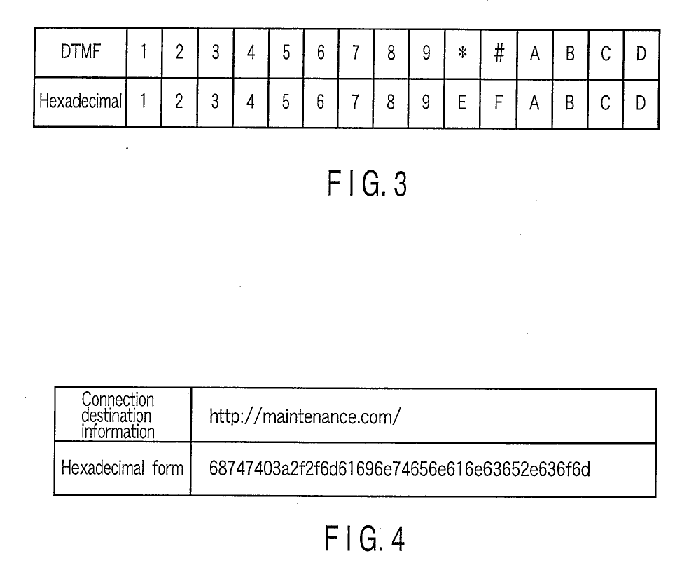

The data format conversion control unit 141 converts the DTMF signal detected by the DTMF detecting unit 18 into connection destination information (URL) of a text format according to a conversion table stored in the memory unit 19. The conversion table stored in the memory unit 19 is composed of a table showing a correspondence relationship between DTMF and American National Standard Cord for Information Interchange (ASCII) codes (hexadecimal form) as shown in FIG. 3 and a table showing a correspondence relationship between the ASCII codes and text character strings as shown in FIG. 4.

The access control unit 142 accesses the maintenance apparatus MT, for example, via the LAN 2, the firewall FW and the public network INW based on the connection destination information converted by the data format conversion control unit 141. As a result, the access control unit 142 establishes connection for control between the maintenance apparatus MT and the telephone main apparatus 1.

An operation of the system having the above constitution will be described below.

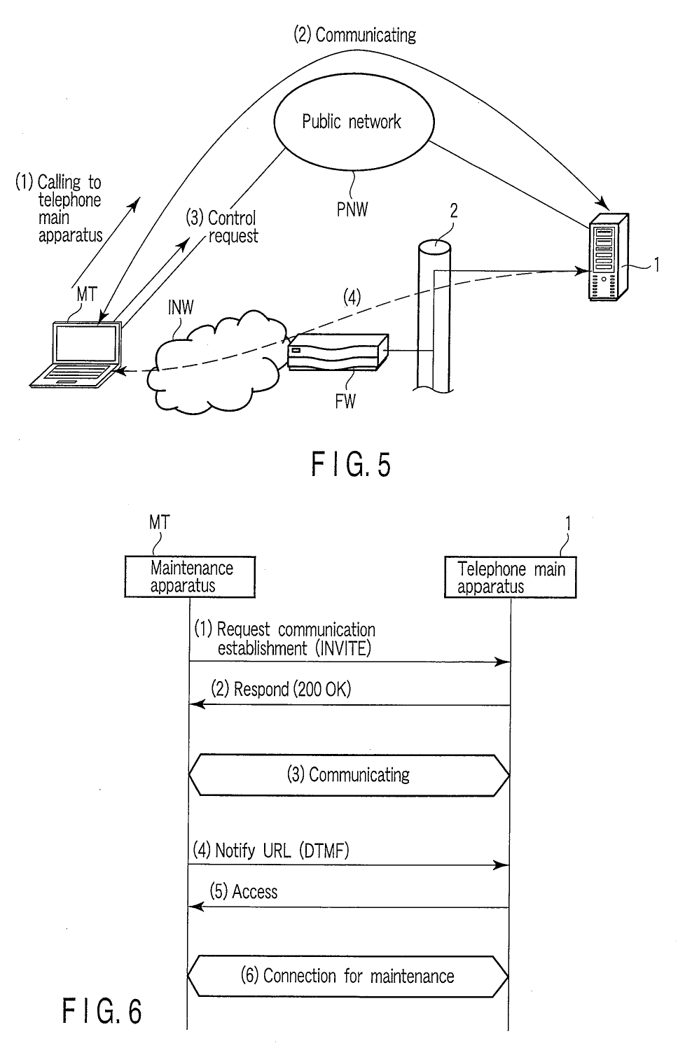

FIG. 5 is a sequence diagram illustrating the operation for establishing the connection for control between the maintenance apparatus MT and the telephone main apparatus 1.

When the telephone main apparatus 1 is remotely controlled by the maintenance apparatus MT, a user of the maintenance apparatus MT performs an outgoing operation on the telephone main apparatus 1 using the maintenance apparatus MT (FIG. 5(1)). As a result, the maintenance apparatus MT creates a communication establishment request for the public network PNW so as to transmit this request to the public network PNW.

When the public network PNW receives the communication establishment request, it calls for the telephone main apparatus 1 as incoming destination. When the telephone main apparatus 1 responds to this calling, a communication link is established between the maintenance apparatus MT and the telephone main apparatus 1 (FIG. 5(2)).

It is assumed that the user performs an operation for requesting remote control of the telephone main apparatus 1 from the maintenance apparatus MT in a state that communication is established between the maintenance apparatus MT and the telephone main apparatus 1 (FIG. 5(3)). As a result, the maintenance apparatus MT transmits a self address (for example, URL (uniform resource locator)) as address information of access destination. At this time, the URL is converted into DTMF. As an example, character strings of the URL are converted into ASCII codes (hexadecimal form), and the ASCII codes of the hexadecimal form are converted into DTMF. The DTMF signal is transmitted to the telephone main apparatus 1 via the public network PNW.

In the telephone main apparatus 1, the DTMF detecting unit 18 detects the received DTMF signal, and converts the DTMF signal into character strings representing connection destination. The telephone main apparatus 1 is connected to the maintenance apparatus MT outside the firewall FW by HTTP (Hypertext Transfer Protocol) based on the acquired URL information (FIG. 5(4)).

When the connection is established, the maintenance apparatus MT transmits instruction commands such as address and file information of sites providing software of the latest version to the telephone main apparatus 1 via HTTP.

The telephone main apparatus 1 acquires a file according to the transmitted instruction.

In the first embodiment, in the state that the communication link is established between the maintenance apparatus MT and the telephone main apparatus 1 via the public network PNW, URL of the maintenance apparatus MT is notified to the telephone main apparatus 1 by using the DTMF signal in the maintenance apparatus MT. As a result, the DTMF signal is converted into URL of the maintenance apparatus MT in the telephone main apparatus 1, and the telephone main apparatus 1 accesses the maintenance apparatus MT as a request source via the firewall FW and the public network INW based on the URL. That is, a trigger for allowing the access to the maintenance apparatus MT from the inside of the firewall FW is given by a firewall FW passable method, so that connection for control is formed from the inside and the remote control from the maintenance apparatus MT is enabled.

Therefore, the remote operation of the telephone main apparatus 1 can be performed in any place on the public network INW by using the maintenance apparatus MT without going to the installation place of the telephone main apparatus 1. Further, the telephone main apparatus 1 and the maintenance apparatus MT can be connected without relaxing the access limitation of the firewall FW. For this reason, a security level of a transmission path does not have to be lowered. As a result, program can be automatically updated, log files can be automatically acquired, services can be controlled and settings can be changed by the maintenance apparatus MT outside the firewall FW.

The central control unit 14 of the telephone main apparatus 1 is provided with a data format conversion control unit 141 for a DTMF signal, and the DTMF signal transmitted from the maintenance apparatus MT is once converted into a character string of hexadecimal form. Thereafter, the character string of the hexadecimal form is converted into URL of a text format. As a result, the DTMF signal can be converted into URL of text format in the telephone main apparatus 1 only by using the maintenance apparatus MT having the function for transmitting a DTMF signal according to a simple procedure, thereby allowing the telephone main apparatus 1 to access the maintenance apparatus MT.

In the first embodiment, since communication of a control signal can be treated equivalently with the normal control of telephone terminals, the compatibility with telephone-related devices is high, and the processes are easily executed.

### Second Embodiment

FIG. 6 is a sequence diagram illustrating an operation for establishing the connection for control between the maintenance apparatus MT and the telephone main apparatus 1 according to a second embodiment of the present invention.

When the telephone main apparatus 1 is remotely controlled by the maintenance apparatus MT, the user of the maintenance apparatus MT calls to the telephone main apparatus 1. As a result, the maintenance apparatus MT creates a communication establishment request (INVITE message) for the telephone main apparatus 1 and transmits this request to the public network INW according to Session Initiation Protocol (SIP) (FIG. 6(1)). When the telephone main apparatus 1 returns a response to the request (200 OK) (FIG. 6(2)), a session for notifying connection destination is formed between the maintenance apparatus MT and the telephone main apparatus 1 via the firewall FW and the public network INW (FIG. 6(3)). Information for recognizing the access for maintenance on the telephone main apparatus 1 side includes extension number registered as for maintenance in advance or a DID number as an access number, or caller information (for example, User to User Information (UUI)).

After the session is established, the maintenance apparatus MT transmits a self address (for example, URL) as address information about access destination. At this time, URL is converted into DTMF. The URL information converted into DTMF is transmitted as audio on Real-time Transport Protocol (RTP)) according to a method similar to that of a normal SIP telephone, or according to a method defined by RFC2833 (FIG. 6(4)).

In the telephone main apparatus 1, the received DTMF signal is detected, and is converted into character strings expressing connection destination. The telephone main apparatus 1 is connected to the maintenance apparatus MT outside the firewall FW by HTTP based on the acquired URL information (FIG. 6(5)).

After the connection is established (FIG. 6(6)), the maintenance apparatus MT transmits address and file information about sites providing software of the latest version, and an instruction command to the telephone main apparatus 1 by HTTP.

The telephone main apparatus 1 acquires the file according to the transmitted instruction.

According to the second embodiment, the remote access to the telephone main apparatus 1 from the external maintenance apparatus MT via the firewall FW is facilitated by using SIP.

### Another Embodiment

The present invention is not limited to the above embodiments. For example, any rule of the conversion from DTMF to URL in the embodiments may be used. For example, the command is obtained by simply converting a character string into hexadecimal form by the ASCII code, but the command may be encrypted according to a special rule. Any method for defining a command may be used. When not only notification of connection destination but also various commands are defined in such command notifying methods, the methods can be applied to the automatic update of software of the apparatus, periodic acquisition of log files, and the remote control of telephony services.

The above embodiments have described the example where the operation of the telephone main apparatus is remotely controlled by the maintenance apparatus on the public network. However, the present invention is not limited to this, and application servers, telephone terminals and voice mail apparatus on LAN can be remotely controlled similarly to the telephone main apparatus.

The above embodiments have described the example where the telephone main apparatus accesses the maintenance apparatus by means of HTTP based on notified URL, but an access method other than HTTP may be used. Further, maintenance commands of devices can be communicated by using (H323, MEGACO, MGCP) of general VoIP (voice over internet protocol).

The constitution of the communication system, the functional constitution of the telephone main apparatus, types of communication apparatuses such as a telephone main apparatus and a voice mail apparatus, the remote control procedure and its contents from the maintenance apparatus can be variously modified without departing from scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus which is connected to a local area network, is connectable to a public network arranged more widely than the local area network via a firewall, and executes a predetermined communication process, the apparatus comprising:
a receiver which receives a Dual Tone Multi Frequency (DTMF) signal for specifying a control request is transmitted from a management apparatus, the control request including connection destination information for specifying a management apparatus, the management apparatus is connected to the public network and remotely controls the communication process;
a calculator which obtains a control request from the DTMF signal; and
a controller which creates a session for management using a known protocol passable through the firewall with respect to the management apparatus based on the connection destination information included in the control request, and allows the management apparatus to execute a process based on contents of the control request.

2. The communication apparatus according to claim 1, when the DTMF signal is transmitted from the management apparatus via a communication link in a state that the communication link is established with respect to the management apparatus,
wherein the calculator obtains the control request from the DTMF signal.

3. The communication apparatus according to claim 1, when the DTMF signal is transmitted from the management apparatus according to a procedure of Session Initiation Protocol (SIP) with respect to the management apparatus,
wherein the calculator obtains the control request from the DTMF signal.

4. A remote control method used in a communication system provided with a communication apparatus which is connected to a local area network and executes a predetermined communication process and a management apparatus which is connectable to the communication apparatus via a firewall and a public network arranged more widely than the local area network and remotely controls a communication operation of the communication apparatus, the method comprising:
allowing the management apparatus to transmit a Dual Tone Multi Frequency (DTMF) signal for specifying a control request to the communication apparatus, the control request including connection destination information for specifying the management apparatus;
obtaining the control request from the DTMF signal in the communication apparatus;
creating a session for management using a known protocol passable through the firewall for the management apparatus based on the connection destination information included in the control request in the communication apparatus; and
executing a process based on contents of the control request in the communication apparatus.
